(19) United States
(12) Patent Application Publication
(10) Pub. No.: US 2025/0340210 A1
(43) Pub. Date: Nov. 6, 2025

(54) SYSTEMS AND METHODS FOR PREDICTIVE DRIVER ASSISTANCE

(71) Applicant: Toyota Motor Engineering & Manufacturing North America, Inc., Plano, TX (US)

(72) Inventors: Rohit Gupta, Santa Clara, CA (US); Amr Abdelraouf, Redwood City, CA (US); Kyungtae Han, Palo Alto, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/656,342

(22) Filed: May 6, 2024

(51) Int. Cl. B60W 50/14; B60W 50/00; G07C 5/00

(52) U.S. Cl. CPC B60W 50/14; B60W 50/0097; G07C 5/008; B60W 2556/45; B60W 2556/50

(57) ABSTRACT

Methods, systems, and apparatus for driver assistance includes one or more vehicle sensors and one or more processors in electronic communication with a memory that stores instructions configured to be executed by the one or more processors. The one or more processors, which can include a vehicle pre-collision system, are configured to receive vehicle data from the one or more vehicle sensors, analyze the vehicle data using a machine learning predictive model to predict a potentially dangerous driving condition at a geographic location that the vehicle is approaching, and, in response to predicting the potentially dangerous driving condition, initiate a countermeasure to prevent the driving condition from occurring. The vehicle can communicate with a remote server to periodically receive updated machine learning models based on historical vehicle/traffic data.

### BACKGROUND

### Field

The present disclosure relates generally to systems and methods for driver assistance and, more particularly, to systems and methods for predicting certain driving conditions, and responding with measures to prevent and/or mitigate these driving conditions.

### Description of the Related Art

Abundant research on vehicles equipped with advanced driver assistance systems (ADAS) that actively provide information about a vehicle state, a driver state, and traffic environment has been recently carried out to reduce drivers' burden and improve convenience. As an example of an ADAS mounted on a vehicle, a lane following assist (LFA) may plan a driving path and control the vehicle to track the desired path using an active control of an electronic power steering (EPS) to provide convenience to a driver. That is, the lane following assist is a system capable of controlling the vehicle or providing a warning to keep the vehicle within its lane during driving. These systems are reactive.

With all kinds of vehicles on roadways, inattentive and/or aggressive drivers, and variable road conditions, drivers may encounter various dangerous scenarios that can lead to a collision, which can cause potential harm to the driver, other vehicle occupants, occupants in nearby vehicles, and/or pedestrians.

Accordingly, there is a need for a system and method for monitoring vehicle and traffic activities to increase road and vehicle safety.

### SUMMARY

In general, one aspect of the subject matter described in this disclosure may be embodied in a driver assistance system for a vehicle. The driver assistance system includes one or more vehicle sensors and one or more processors. The processor(s) is/are configured to receive vehicle data from the one or more vehicle sensors, the vehicle data includes a location of a vehicle. The processor(s) is/are further configured to analyze the vehicle data using a machine learning predictive model to predict a driving condition at a geographic location that the vehicle is approaching. The processor(s) is/are further configured to, in response to predicting the driving condition at the geographic location that the vehicle is approaching, initiate a countermeasure to prevent the driving condition from occurring.

These and other embodiments may optionally include one or more of the following features.

In various aspects, the countermeasure includes adjusting a threshold of the driver assistance system in response to the vehicle approaching the geographic location. In various aspects, the countermeasure includes adjusting a parameter of the vehicle in response to the vehicle approaching the geographic location. In various aspects, the countermeasure includes sending a driver assistance message to a user interface in the vehicle warning a driver of the vehicle of the predicted driving condition in response to the vehicle approaching the geographic location.

The one or more processors can be further configured to create a spatio-temporal probability data based upon the vehicle data, the spatio-temporal data includes a history of traffic events at one or more geographic locations for a plurality of vehicles and/or a history of driver events at the one or more geographic locations for the vehicle. The machine learning predictive model can use the spatio-temporal probability data to predict the driving condition at the geographic location that the vehicle is approaching.

The one or more processors can be further configured to process the vehicle data to determine at least one of a geographic location of the vehicle where a pre-collision system of the vehicle was activated, a driver event, a traffic event, a near miss event, or an anomaly event.

The one or more processors can include an electronic control unit located onboard the vehicle and a remote server. The electronic control unit can be configured to send the vehicle data to the remote server. The process of creating the spatio-temporal probability data based upon the vehicle data can be performed using the remote server. The electronic control unit can be configured to receive the spatio-temporal probability data from the remote server via a wireless network.

The one or more processors can be further configured to apply a machine learning framework to generate the machine learning predictive model. The process of applying the machine learning framework to generate the machine learning predictive model can be performed using the remote server. The electronic control unit can be configured to receive the machine learning predictive model from the remote server via a wireless network.

In another aspect, the subject matter may be embodied in a method. The method can include receiving a vehicle data from one or more vehicle sensors, analyzing the vehicle data using a machine learning predictive model to predict a driving condition at a geographic location that the vehicle is approaching, and, in response to predicting the driving condition at the geographic location that the vehicle is approaching, initiating a countermeasure to prevent the driving condition from occurring. The vehicle data includes a location of a vehicle.

In another aspect, the subject matter may be embodied in a non-transitory computer readable medium having stored contents that cause one or more computing systems to perform automated operations. The automated operations include receiving, by the one or more computing systems, a vehicle data from at least one vehicle sensor, the vehicle data includes a location of a vehicle. The automated operations include analyzing, by the one or more computing systems, the vehicle data using a machine learning predictive model to predict a driving condition at a geographic location that the vehicle is approaching. The automated operations include, in response to predicting the driving condition at the geographic location that the vehicle is approaching, initiating, by the one or more computing systems, a countermeasure to prevent the driving condition from occurring.

Various aspects are described in a step-by-step manner. However, the methods described herein can be performed continuously while a vehicle is driving using rolling windows across the incoming vehicle data and/or driver data.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 is a block diagram of an example driver assistance system according to an aspect of the invention.

FIG. 2 is a block diagram of example driver assistance system according to an aspect of the invention.

FIG. 3 is a schematic view of a vehicle in traffic at an intersection that is encountering an example dangerous driving condition according to an aspect of the invention.

FIG. 4 is a flow diagram of an example driver assistance method which can be performed by the driver assistance system of FIG. 1 or FIG. 2 according to an aspect of the invention.

FIG. 5 is a flow diagram of an example driver assistance method which can be performed by the driver assistance system of FIG. 1 or FIG. 2 according to an aspect of the invention.

### DETAILED DESCRIPTION

Disclosed herein are systems, vehicles, and methods for predictive driver assistance. Particular embodiments of the subject matter described in this disclosure may be implemented to realize one or more of the following advantages. The monitoring, prediction, and mitigation system (“driver assistance system”) detects, identifies, predicts, and/or anticipates potentially dangerous driving conditions (e.g., a collision event, road debris, animals, pedestrians, etc.) and/or driver confusion (e.g., confusion about a route or a particular traffic lane) that may potentially occur in the near future with a vehicle based on historical data of traffic events at a particular geographic location. The driver assistance system can control various aspects of the vehicle to warn a driver of the potentially dangerous driving condition(s) and/or to mitigate the risk of a collision event, thereby improving vehicle safety. The driver assistance system can anticipate a potential collision event and/or driver confusion and therefore tends to prevent collisions and/or driver confusion before they even occur. Aspects of the driver assistance system used for detecting, identifying, predicting, and/or anticipating a collision, or a potential collision, with another vehicle can be referred to herein as a pre-collision system. The pre-collision system can form part of the driver assistance system or can be separate from the driver assistance system.

The driver assistance system can utilize one or more supervised machine learning predictive models to take into account vehicle data, driver data, traffic data, different environmental factors, and/or circumstances of the environment. The driver assistance system can utilize a Global Positioning System (GPS) unit for detecting location data including a current location of the vehicle to determine various vehicle traffic, pedestrian traffic, and/or event information (real-time and/or historical) of the surrounding environment. In this manner, the driver assistance system may account for various environmental factors, such as the time of day, the location, the weather, and/or other factors, in predicting the driving conditions and/or anticipated driver confusion. This allows for a more precise and accurate understanding of different risk levels at different locations, times of day, etc. to accurately determine whether a potentially dangerous driving condition is predicted to occur.

Other benefits and advantages include the use of artificial intelligence including machine learning algorithms with models to anticipate, predict, or otherwise determine when a potentially dangerous driving condition occurs or is about to occur. By anticipating, predicting, or otherwise determining a driving condition, the driver assistance system proactively anticipates the driving condition and may act to prevent, report, or otherwise record or document the driving condition. For example, the driver assistance system may alert the driver to encourage a corrective response from the driver to prevent the driving condition. In another example, the driver assistance system may take control of various parameters of the vehicle to prevent the driving condition. The driver assistance system may learn from each instance of a detected dangerous driving event and/or the driver's reaction thereto.

Various aspects refer to “soft” countermeasures and “hard” countermeasures. In general, “soft” countermeasures refer to those that try to nudge or shape behavior through suggestion or encouragement, while “hard” refer to those that directly modify vehicle behavior (e.g., pedal force, availability of features, acceleration limitations, braking, etc.).

As defined herein, “real-time” can, in some aspects, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

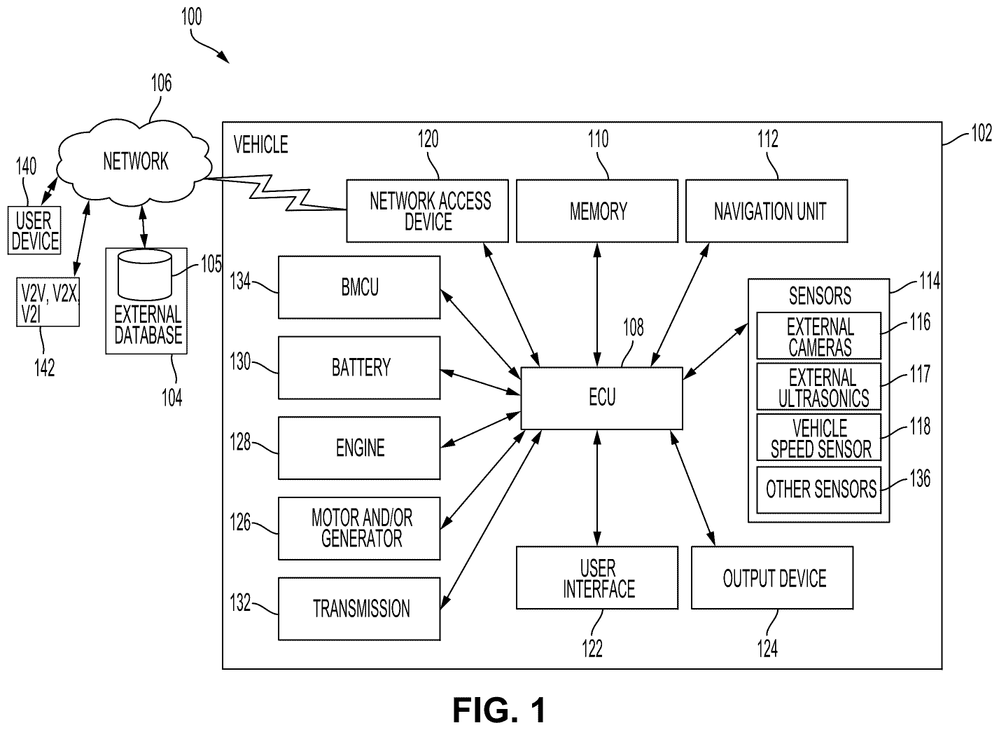

FIG. 1 is a block diagram of a driver assistance system 100. The driver assistance system 100 may be retrofitted, coupled to, include or be included within a vehicle 102. The driver assistance system 100 may couple to, connect to, or include a remote server 104. The remote server can be coupled to, include, or be included with an external database 105. The remote server 104 may include one or more processors or controllers specifically designed for processing the sensor data received from the ECU 108, classifying various driving events from the sensor data, training machine learning algorithms with the sensor data, and preparing spatio-temporal probability data based upon the sensor data. The driver assistance system 100 may have a network 106 that links the server 104 and the external database 105 with the vehicle 102. The network 106 may be a local area network (LAN), a wide area network (WAN), a cellular network, the Internet, or combination thereof, that connects, couples and/or otherwise communicates between the vehicle 102 and the server 104 and/or external database 105.

The driver assistance system 100 detects, identifies, predicts, and/or anticipates collision and/or driver confusion that occurs and/or may potentially occur in the near future with the vehicle 102. The driver assistance system 100 utilizes a predictive model to detect, identify, predict, and/or anticipate vehicle collision and/or driver confusion and activates one or more countermeasures to assist the driver to avoid a collision and/or avoid driver confusion.

The driver assistance system 100 may include or be retrofitted or otherwise coupled with the vehicle 102. A vehicle 102 is a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The driver assistance system 100 includes one or more processors, such as an electronic control unit (ECU) 108 and a memory 110. The driver assistance system 100 may include other components, such as a navigation unit 112, one or more sensors 114 (also referred to herein as vehicle sensors) including one or more external cameras 116, one or more external ultrasonic sensors 117, a vehicle speed sensor 118, other vehicle sensors 136, a network access device 120, a user interface 122, and/or an output device 124. Other sensors 136 can include one or more cameras, one or more radar sensors, LiDAR, microphones, etc. The driver assistance system 100 may couple, connect to, and/or include one or more vehicle components such as the motor and/or generator 126, the engine 128, the battery 130, the transmission 132 and/or the battery management control unit (BMCU) 134.

The ECU 108 may be implemented as a single ECU or as multiple ECUs. The ECU 108 may be electrically coupled to some or all of the other components within the vehicle 102, such as the motor and/or generator 126, the transmission 132, the engine 128, the battery 130, the BMCU 134, the memory 110, the network access device 120, and/or one or more sensors 114. The ECU 108 may include one or more processors or controllers specifically designed for detecting, identifying, predicting, and/or anticipating any potentially dangerous driving conditions with the vehicle 102 and/or driver confusions.

The ECU 108 may be coupled to a memory 110 and can execute instructions that are stored in the memory 110. The memory 110 may be coupled to the ECU 108 and store instructions that the ECU 108 executes. The memory 110 may include one or more of a Random Access Memory (RAM) or other volatile or non-volatile memory. The memory 110 may be a non-transitory memory or a data storage device, such as a hard disk drive, a solid-state disk drive, a hybrid disk drive, or other appropriate data storage, and may further store machine-readable instructions, which may be loaded and executed by the ECU 108. Moreover, the memory 110 may be used to record and store data before, after, and/or during the occurrence of an anticipated and/or detected driver event, traffic event, near miss, and/or anomaly.

The driver assistance system 100 may include a user interface 122. The driver assistance system 100 may display one or more notifications on the user interface 122. The one or more notifications on the user interface 122 may notify occupants of the vehicle when the driver assistance system 100 is initialized or activated. The user interface 122 may include an input/output device that receives user input from a user interface element, a button, a dial, a microphone, a keyboard, and/or a touch screen. For example, the user interface 122 may receive user input that may include configurations as to the amount of sensor data or the length of the video to record when a pre-collision event is determined. Other configurations may include a preference for the magnitude or the type of countermeasure for preventing a collision, for example.

The driver assistance system 100 may include an output device 124. The output device 124 may be an audio indicator, a visual indicator, a communication device, or other output device. The audio or visual indicator may be used to sound an alarm or flash an alarm, respectively, for example. The communication device may be used to contact the owner of the vehicle, the police, an insurance company, or other entity and provide recordings to such entities. The communication device may notify or provide documentation to the owner of the vehicle 102 that a potentially dangerous driving condition is about to occur, has occurred, or is occurring. The ECU 108 may send an output signal to the output device 124, such as a display, a speaker, an audio and/or visual indicator, or a refreshable braille display. For example, the output device 124 may display an alert, a warning, or a specific countermeasure being taken by the ECU 108.

The driver assistance system 100 may include a network access device 120. The network access device 120 may include a communication port or channel, such as one or more of a Wi-Fi unit, a Bluetooth® unit, a radio frequency identification (RFID) tag or reader, or a cellular network unit for accessing a cellular network (such as 3G, 4G or 5G). The network access device 120 may transmit data to and receive data from the remote server 104 and/or the external database 105. For example, the ECU 108 may communicate with the remote server 104 and/or the external database 105 to obtain a baseline model and/or a predictive algorithm that consider activities and/or objects at a current location of the vehicle 102, via the network 106. The driver assistance system 100 may use the baseline model and/or the predictive algorithm to detect, identify, predict, and/or anticipate potentially dangerous driving conditions of the vehicle 102.

The network access device 120 may transmit data to and receive data from a user device 140 (e.g., a smart phone, a tablet, a personal computer, etc.) located remotely from the vehicle 102. The driver assistance system 100 may display one or more notifications on the user device 140, similar to user interface 122. Accordingly, the user device 140 can have a user interface whereby a user can communicate with the ECU 108 from a remote location.

The network access device 120 may transmit data to and receive data from other databases 142, for example using vehicle-to-vehicle (V2V) communication, vehicle-to-everything (V2X), and/or vehicle-to-infrastructure (V2I). For example, driver assistance system 100 can enable vehicle 102 to exchange vehicle data with a second vehicle using V2V communication technology. Driver assistance system 100 can receive location data such as traffic congestion, weather advisories, bridge clearance levels, traffic light status, and/or crime data to inform the driver assistance system 100 of conditions at or near the location of the vehicle 102 or a location where the vehicle 102 is headed using V2V, V2I, and/or V2X communication technology. Accordingly, the vehicle 102 may communicate with another vehicle or a network using V2V, V2I, and/or V2X communications via the network access device 120.

The driver assistance system may further include a navigation unit 112. The navigation unit 112 may be integral to the vehicle 102 or a separate unit coupled to the vehicle 102, such as a personal device with navigation capabilities. When the navigation unit 112 is separate from the vehicle 102, the navigation unit 112 may communicate with the vehicle 102 via the network access device 120. In some implementations, the vehicle 102 may include a GPS unit for detecting location data including a current location of the vehicle 102 and date/time information instead of the navigation unit 112. In that regard, the ECU 108 may perform the functions of the navigation unit 112 based on data received from the GPS unit. At least one of the navigation unit 112 or the ECU 108 may predict or propose a route set that includes a starting location and a destination location. The navigation unit 112 or the ECU 108 may perform navigation functions. Navigation functions may include, for example, route and route set prediction, providing navigation instructions, and receiving user input such as verification of predicted routes and route sets or destinations. Other information, such as a current speed of the vehicle 102, may be extrapolated, interpreted, or otherwise calculated from the data obtained from the navigation unit.

The navigation unit 112 may provide and obtain navigational map information including location data, which may include a current location, a starting location, a destination location and/or a route between the starting location or current location and the destination location of the vehicle 102. The navigation unit 112 may include a memory (not shown) for storing the route data. The navigation unit 112 may receive data from other sensors capable of detecting data corresponding to location information. For example, the other sensors may include a gyroscope or an accelerometer.

The navigational map information may include entity information. The entity information may include locations or places of interest, such as government buildings, commercial businesses, schools, tourist attractions, or other places of interest. These different entities may be one factor in determining a potentially dangerous driving conditions, driver confusion, and/or anomaly data.

The driver assistance system 100 may further include the one or more sensors 114. The one or more sensors 114 may include one or more external cameras 116, one or more external ultrasonic sensors 117, one or more vehicle speed sensors 118, and/or other sensors 136. The one or more external cameras 116 may include multiple cameras positioned on the outside of the vehicle 102 and/or within the vehicle 102 but directed outward to capture different views of the surrounding environment outside the vehicle 102. The one or more external ultrasonic sensors 117 may include multiple ultrasonic sensors positioned on the outside of the vehicle 102 and/or within the vehicle 102 but directed outward to capture different views of the surrounding environment outside the vehicle 102. The one or more vehicle speed sensors 118 can measure the amount of rotation of one or more of the multiple wheels of the vehicle 102 to determine a speed of the vehicle 102, which can also be used to determine whether the vehicle 102 is stationary and/or parked. The one or more sensors 114 may include other sensors 136 to measure road condition(s), the weather, the ambient lighting surrounding the vehicle 102, or other environmental factors that may be used to predict potentially dangerous driving conditions. For example, the other sensors 136 can include a gyroscope and/or accelerometer for measuring attitude and/or acceleration of the vehicle 102. The other sensors 136 can include one or more radar sensors. The one or more radar sensors may include multiple radar sensors positioned on the outside of the vehicle 102 and/or within the vehicle 102 but directed outward to capture different views of the surrounding environment outside the vehicle 102.

The one or more sensors 114 can include one or more external cameras 116, one or more external ultrasonic sensors 117, and/or one or more external other sensors 136 (e.g., radar sensors) which can be positioned along the exterior of the vehicle 102, such as along the roof, the trunk, the sides, and/or the front of the vehicle 102. The positions of the one or more sensors 114 can vary depending on the type of vehicle, among other factors. The different views of the surrounding environment may be used to form a panoramic or 360-degree image and/or view of the surrounding environment outside the vehicle 102, which allows the driver assistance system 100 to detect other vehicles and/or objects outside the vehicle 102, such as vehicles in front, alongside, or behind the vehicle 102. The one or more external cameras 116 may capture image data that includes a single frame or image or a continuous video of the surrounding environment outside the vehicle 102.

The driver assistance system 100 may couple, connect to, and/or include one or more vehicle components. The one or more vehicle components may include a motor and/or generator 126. The motor and/or generator 126 may convert electrical energy into mechanical power, such as torque, and may convert mechanical power into electrical energy. The motor and/or generator 126 may be coupled to the battery 130. The motor and/or generator 126 may convert the energy from the battery 130 into mechanical power, and may provide energy back to the battery 130, for example, via regenerative braking. In some implementations, the vehicle 102 may include one or more additional power generation devices such as the engine 128 or a fuel cell stack (not shown). The engine 128 combusts fuel to provide power instead of and/or in addition to the power supplied by the motor and/or generator 126.

The battery 130 may be coupled to the motor and/or generator 126 and may provide electrical energy to and receive electrical energy from the motor and/or generator 126. The battery 130 may include one or more rechargeable batteries.

The BMCU 134 may be coupled to the battery 130 and may control and manage the charging and discharging of the battery 130. The BMCU 134, for example, may measure, using battery sensors, parameters used to determine the state of charge (SOC) of the battery 130. The BMCU 134 may control the battery 130.

The one or more vehicle components may include the transmission 132. The transmission 132 may have different gears and/or modes, such as park, drive and/or neutral and may shift between the different gears. The transmission 132 manages the amount of power that is provided to the wheels of the vehicle 102 given an amount of speed.

The driver assistance system 100 may include or be coupled to the external database 105. A database is any collection of pieces of information that is organized for search and retrieval, such as by a computer, and the database may be organized in tables, schemas, queries, reports, or any other data structures. A database may use any number of database management systems. The external database 105 may include a third-party server or website that stores or provides information. The information may include real-time information, periodically updated information, or user-inputted information. A server may be a computer in a network that is used to provide services, such as accessing files or sharing peripherals, to other computers in the network.

The external database 105 may store personalized driver data, vehicle data, machine learning models, and/or machine learning training algorithms models, among other data. The external database 105 may be updated and/or provide updates in real-time. The external database 105 may store and/or provide the driver data, vehicle data, and/or machine learning algorithms/models to the ECU 108. The external database 105 may also store environmental factors, such as weather information or time of day information, and provide the environmental factors to the ECU 108 to assist in predicting driving conditions and/or driver confusion. The weather information may include the temperature, wind, humidity, road conditions, amount of precipitation, and/or other weather factors that may affect the determination of dangerous road conditions. For example, when the weather is cold and there is precipitation, the driver assistance system 100 can be more likely to find certain vehicle maneuvers and/or speeds to be dangerous. As another example, personalized driver and/or vehicle data that indicates that a driver and/or vehicle has historic driving behavior and/or patterns at certain geographic locations can be used by the driver assistance system 100 to generate a probability of those same driver behavior(s)/pattern(s) occurring again and/or can be used by the driver assistance system 100 when predicting dangerous driving conditions as the driver approaches these same geographic locations.

The ECU 108 may analyze sensor feedback from the sensors 114 of the vehicle 102, among other data, and apply these inputs into a machine learning model for real-time driver assistance (e.g., pre-collision warnings, route recommendations, and/or other driver assistance). The ECU 108 may utilize, generate, and/or update predictive models to detect, identify, predict, and/or anticipate dangerous driving conditions and/or driver confusions before these events occur. The ECU 108 can apply “soft” and/or “hard” countermeasures to help prevent vehicle collisions and/or driver confusion.

The ECU 108 can analyze personalized spatio-temporal probability data generated based upon driver event data (e.g., data indicating braking behavior, acceleration behavior, lane change behavior, turning behavior, etc.), traffic event data (e.g., traffic congestion, other vehicles that merge into a lane and thereby cause following vehicles to brake, etc.), near miss events (e.g., when a first vehicle nearly, but does not, collide with a second vehicle), and/or anomaly data (e.g., a detected event that does not normally occur at a given geographic location). Driver event data can be predicted, detected, and/or derived from sensor data (e.g., brake pedal deflection, accelerator pedal deflection, acceleration, speed, steering wheel angle, etc.). Traffic event data can be predicted, detected, and/or derived from sensor data (e.g., sonar sensor data, camera sensor data, ultrasonic sensor data, and other traffic data received via V2I, V2X, and/or V2V communications, such as traffic cameras and/or radar data received from infrastructure and/or other vehicles, etc.). Near miss events can be predicted, detected, and/or derived from sensor data (e.g., sonar sensor data, camera sensor data, ultrasonic sensor data, and other traffic data received via V2I, V2X, and/or V2V communications, such as traffic cameras and/or radar data received from infrastructure and/or other vehicles, etc.). Anomaly events can be a driver action that does not normally occur at a given location. Anomaly events can be detected via one or more vehicle sensors.

The spatio-temporal probability data can include a data set that maps detected driver confusion events and/or near miss events, which can include driver event data, traffic event data, near miss events, and/or anomaly data, with a geographic location that the driver confusion event and/or near miss event occurred. The spatio-temporal probability data can include aggregated data from a plurality of vehicles or systems.

Additional data that can be included with, and or considered together with, the spatio-temporal probability data include environmental factors (e.g., traffic, buildings, pedestrians, weather, road conditions, time of day, etc.). The ECU 108 and compare the data to a baseline and/or input the data into a model to detect, identify, predict, and/or anticipate any dangerous driving conditions and/or conditions that could cause driver confusion. If dangerous driving conditions are predicted or otherwise determined, the ECU 108 may act to record, alert, provide, or mitigate consequences of the dangerous driving condition.

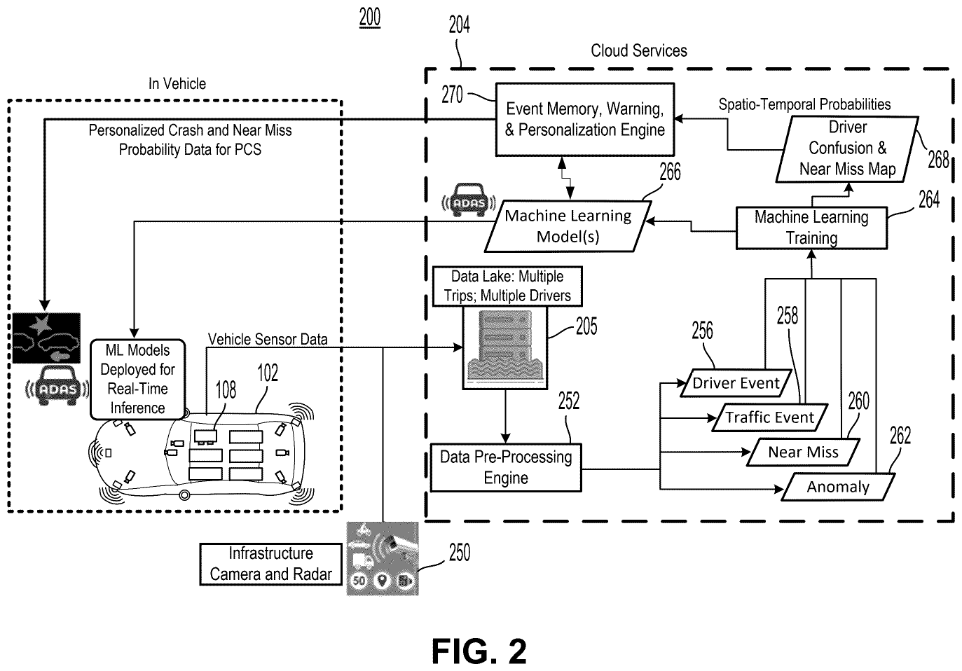

FIG. 2 is a block diagram of a driver assistance system 200 including a flow chart of various data for generating a predictive machine learning model. One or more computers or one or more data processing apparatuses, for example, the ECU 108 and the remote server 104 of the driver assistance system 100 of FIG. 1, appropriately programmed, may implement aspects of the illustrated block diagram.

With combined reference to FIG. 1 and FIG. 2, the ECU 108 can send vehicle sensor data to a remote server 204. The remote server 204 can be similar to remote server 104 of FIG. 1. The sensor data can be stored in an external database 205. The external database 205 can be similar to the external database 105 of FIG. 1. The external database 205 can be a data lake that stores the sensor data from the vehicle 102, other vehicles, and/or infrastructure 250 (e.g., traffic cameras, radar sensors, etc.). The data can be pre-processed at block 252, including data cleaning, feature selection, data labeling, and/or event classification. For example, the data can be pre-processed to obtain one or more features. In various aspects, the features are computed from the raw data. The features can include a mean, a median, a mode, a rolling average, a cumulative sum, etc. of the sensor data. The features can include filtered sensor data. The remote server 204 can execute a feature selection algorithm to select a subset of relevant features from the raw data to enhance model performance, interpretability, and efficiency. The remote server 204 can align, shift, skew, rotate, crop, and/or filter the raw data. The data subsets can be labeled for further processing.

One or more events can be derived or otherwise determined from the data. For example, the data can be classified into driver events 256, traffic events 258, near miss events 260, and/or anomaly events 262. Each of these events can be input into a machine learning training engine 264. The machine learning training engine 264 can be used to generate one or more machine learning models 266 for predicting dangerous driving conditions and/or driver confusion. The one or more machine learning models 266 can be periodically sent to the vehicle 102 and can be executed using the ECU 108 to assist a driver as approaching driving hazards are predicted.

The machine learning training engine 264 may train a neural network when using artificial intelligence or machine learning. The machine learning training engine 264 can receive an expanded data set of past data to train the neural network. The expanded training set may be developed by applying mathematical algorithms to the acquired set of data. The neural network is then trained with the expanded data set using a machine learning algorithm that uses a mathematical function to adjust certain weighting. The machine learning training engine 264 can also use an iterative training algorithm to re-train with additional data, including data received from the vehicle 102.

In various aspects, one or more of the events (e.g., driver events 256, traffic events 258, near miss events 260, and/or anomaly events 262) can be input into the machine learning training algorithm and/or model. The events can include environment data and/or location data. In various aspects, the machine learning training engine 264 is a supervised machine learning predictive algorithm. For example, the machine learning algorithm and/or model can establish a relationship between the features and/or the components of the vehicle data and the labeled events 256, 258, 260, 262 in the data using interactions and weights. The machine learning algorithm and/or model can implement one or more machine learning techniques to analyze feature vectors within a single domain or across different domains to determine the optimal clustering given a set of input nodes. Machine learning is an area of computer science in which the goal is to develop models using example observations (i.e., training data), that can be used to make predictions on new observations. The models or logic are not based on theory but are empirically based or data driven. In this regard, the remote server 204 can periodically update the machine learning model(s) 266 and send updated model(s) 266 to the vehicle 102. The machine learning model 266 is trained using vehicle and infrastructure data received from a plurality of vehicles, such as vehicle 102 and/or other traffic infrastructure 250.

Machine learning can be categorized as supervised or unsupervised. In supervised learning, the training data examples contain labels for the outcome variable of interest. There are example inputs and the values of the outcome variable of interest are known in the training data. The goal of supervised learning is to learn a method for mapping inputs to the outcome of interest. The supervised models then make predictions about the values of the outcome variable for new observations. Supervised learning methods include boosting, neural networks, random forests, support vector machines, among others.

Boosting is a machine learning algorithm which finds a highly accurate hypothesis (e.g., low error rate) from a combination of many “weak” hypotheses (e.g., substantial error rate). Given a data set comprising examples within a class and not within the class and weights based on the difficulty of classifying an example and a weak set of classifiers, boosting generates and calls a new weak classifier in each of a series of rounds. For each call, the distribution of weights is updated that indicates the importance of examples in the data set for the classification. On each round, the weights of each incorrectly classified example are increased, and the weight of each correctly classified example is decreased so the new classifier focuses on the difficult examples (i.e., those examples have not been correctly classified).

Neural networks are inspired by biological neural networks and comprise an interconnected group of functions or classifiers that process information using a connectionist approach. Neural networks change their structure during training, such as by merging overlapping detections within one network and training an arbitration network to combine the results from different networks. Examples of neural network-based approaches include the multilayer neural network, the auto associative neural network, the probabilistic decision-based neural network (PDBNN), and the sparse network of winnows (SNOW).

A random forest is a machine learning algorithm that relies on a combination of decision trees in which each tree depends on the values of a random vector sampled independently and with the same distribution for all trees in the forest. A random forest can be trained for some number of trees ‘T’ by sampling ‘N’ cases of the training data at random with replacement to create a subset of the training data. At each node, a number ‘m’ of the features are selected at random from the set of all features. The feature that provides the best split is used to do a binary split on that node. At the next node, another number ‘m’ of the features are selected at random, and the process is repeated.

A support vector machine is a machine learning algorithm for calculating a boundary that best separates a set of unit data elements in an n-dimensional space into two classes. The boundary is calculated in such a manner as to maximize the distance to the boundary (margin) for each class.

In various aspects, the machine learning training engine 264 can utilize any of these machine learning frameworks to generate the machine learning model 266.

In various aspects, the remote server 204 can create spatio-temporal probability data 268. The spatio-temporal probability data 268 can include a probability of a particular event (e.g., a near miss, a driver confusion, a driver event, a traffic event, etc.) happening at a particular geographic location. For example, the spatio-temporal probability data 268 can include a list of events, and the probability that each event can occur, for a plurality of geographic locations. Table 1 is an example table mapping driving events at a particular geographic location. Table 1 can form a part of the spatio-temporal probability data 268.

TABLE 1
Spatio-Temporal Probability Data

| Geographic Location {lat, lon} | Probability |
|---|---|
| Driver Event #1 | 43% |
| Traffic Event #1 | 35% |
| Near Miss | 40% |

In Table 1, a first driver event (e.g., a sharp deceleration as a result of a driver rapidly pressing the brake pedal) can be associated with a particular geographic location {lat, lon} and a probability (e.g., 43%) of the first driver event happening can be included. Similarly, a first traffic event (e.g., a merging vehicle which causes the following vehicle(s) to rapidly decelerate) can be associated with the particular geographic location and a probability (e.g., 35%) of the first traffic event happening can be included. Similarly, a near miss event (e.g., detection of a first vehicle nearly colliding with another vehicle, such as a lead vehicle) can be associated with the particular geographic location and a probability (e.g., 40%) of the near miss event happening can be included. The probability can be calculated based on historical vehicle and/or infrastructure data. The probability can also vary depending on the time of day, day of the week, weather, among other factors.

The remote server 204 can prepare and send the spatio-temporal probability data 268, for example using an event memory, warning, and personalization engine 270 for a particular vehicle, such as vehicle 102. The vehicle 102 can receive the spatio-temporal probability data 268 from the remote server 204, which can be utilized by the driver assistance system 100 for detecting, identifying, predicting, and/or anticipating dangerous driving events and/or potential traffic or road scenarios that can cause driver confusion. In various aspects, the machine learning model(s) 266 can include the spatio-temporal probability data 268. The machine learning model(s) 266 and/or the spatio-temporal probability data 268 can be stored in the memory 110 for use by the ECU 108. In this manner, the computationally expensive calculations can be performed in a cloud server and then the output of these calculations (i.e., the machine learning model(s) 266 and/or the spatio-temporal probability data 268) are periodically uploaded to the vehicle 102 for real-time driver assistance.

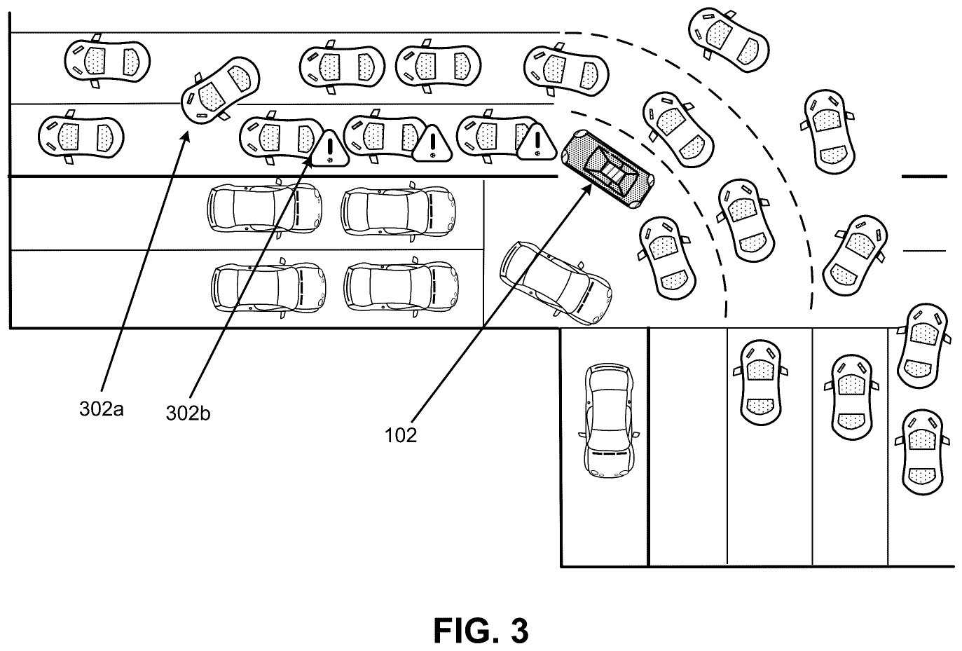

FIG. 3 is an example traffic intersection illustrating a driving event where the vehicle 102 experiences a dangerous driving event which could potentially cause a collision. In the illustrated scenario, a lead vehicle 302a cuts into the lane ahead of where the vehicle 102 is located. This maneuver causes a following vehicle 302b to sharply decelerate, which in turn causes a cascading effect on the following vehicles which must also sharply decelerate in order to avoid a collision with the leading vehicle. In such a scenario, and assuming all of the vehicles between the lead vehicle 302a and the vehicle 102 are equipped with a driver assistance system similar to driver assistance system 100 of FIG. 1, the vehicles could report these events to the remote server 104. The remote server 104 can make note of these events and create the spatio-temporal probability data 268 based upon these reports and send the spatio-temporal probability data 268 (or a machine learning model 266 that incorporates this data) to the vehicle 102. Assuming the vehicle 102 is equipped with a driver assistance system 100 which includes this spatio-temporal data (e.g., from historical events at this location), the driver assistance system 100 of the vehicle 102 can implement one or more countermeasures to warn the driver of the approaching hazard, and/or to prevent a collision. For example, with combined reference to FIG. 1 and FIG. 3, in response to detecting, identifying, predicting, and/or anticipating a dangerous driving condition, the ECU 108 can be configured to implement a “soft” countermeasure, for example by displaying a warning or behavioral nudge. Stated differently, the driver assistance system 100 may operate or control one or more vehicle components in response to predicting the risky driver behavior. For example, the ECU 108 can send a warning signal to the user interface 122 and/or the output device 124 to warn the driver that a dangerous driving condition has been predicted. The warning signal can be a visual signal (e.g., a light on a vehicle dash cluster), an audio signal, and/or a haptic signal (e.g., a vibration within the driver's seat and/or steering wheel that provides a tactile alert to the driver). An example soft countermeasure can include displaying a driver assistance message to a driver, such as “proceed with caution.” The soft countermeasure can encourage the driver to use driver convenience systems (e.g., adaptive cruise control, lane keeping assist, etc.). The soft countermeasure can include other alerts, warnings, HMI (human-machine interface), etc. as desired.

In response to detecting, identifying, predicting, and/or anticipating a dangerous driving condition, the ECU 108 can be configured to implement a “hard” countermeasure, for example by modifying vehicle performance (e.g., limiting vehicle speed and/or acceleration). In this regard, the “hard” countermeasure can include modifying a parameter of the vehicle 102, such as a speed of the vehicle 102, an acceleration of the vehicle 102, an accelerator pedal force, a steering angle of a steering wheel of the vehicle 102, and/or a slight adjustment to or turn of the steering wheel of the vehicle 102. For example, the ECU 108 can modify vehicle performance by limiting one or more signals sent to the engine 128, the motor and/or generator 126, and/or the transmission 132 to limit vehicle speed and/or acceleration.

In various aspects, a countermeasure can include modifying, by the ECU 108, a threshold of the driver assistance system 100 in response to the vehicle approaching the geographic location. For example, when a dangerous driving condition is detected, the ECU 108 can modify a threshold of the pre-collision system of the vehicle 102 to warn the driver of a nearby vehicle, pedestrian, or object. For example, if the pre-collision system is programmed to issue a warning and/or to apply brakes when a “time to collision” is detected to be within first predetermined duration, such as two seconds, the ECU 108 can modify the pre-collision system to issue a warning and/or apply brakes when the “time to collision” is detected to be within a second predetermined duration, such as four seconds, or some other duration greater than two seconds, so that the pre-collision system is more sensitive to potential hazards.

In an example, if the dangerous driving condition is determined to be speeding, the ECU 108 can issue messaging to the driver such as “slow down,” the ECU 108 can modify accelerator pedal force, the ECU 108 can activate a seat vibration feedback signal, the ECU 108 can enable adaptive cruise control at a lower speed, among other vehicle parameter adjustments.

In another example, if the dangerous driving condition is determined to be tailgating, the ECU 108 can issue messaging to the driver such as “increase headway,” the ECU 108 can modify adaptive cruise control distance, the ECU 108 can display green, yellow, and/or red headway to indicate a headway distance, among other vehicle parameter adjustments.

In another example, if the dangerous driving condition is determined to be a near miss event, such as when a leading vehicle stops or slows suddenly in front of the vehicle 102, the ECU 108 can issue messaging to the driver such as “sudden stops ahead,” the ECU 108 can modify adaptive cruise control distance, the ECU 108 can display green, yellow, and/or red headway to indicate a headway distance, the ECU 108 can limit acceleration of the vehicle 102, the ECU 108 can apply braking to the vehicle 102, among other vehicle parameter adjustments.

In another example, if the dangerous driving condition is determined to be an obstructed view, such as when an approach to an intersection has an elevation change that makes it difficult to see oncoming traffic, lanes, lights, etc., the ECU 108 can issue messaging to the driver such as “obstructed views ahead” or “use left lane,” or provide other driving directions, among other vehicle parameter adjustments.

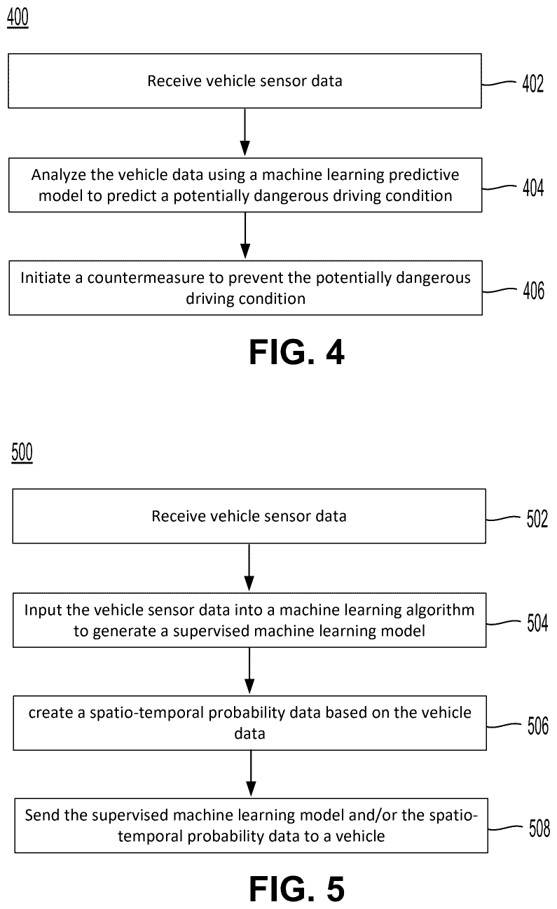

FIG. 4 is a flow diagram of an example process 400 for predictive driver assistance. One or more computers or one or more data processing apparatuses, for example, the ECU 108 of the driver assistance system 100 of FIG. 1, appropriately programmed, may implement the process 400. Various aspects of the process 400 are similar to the process described with respect to FIG. 2.

With combined reference to FIG. 1 and FIG. 4, the ECU 108 can receive vehicle sensor data from the one or more sensors 114 at step 402. The ECU 108 can analyze the vehicle data using a machine learning predictive model, such as the machine learning model 266 of FIG. 2, to predict a potentially dangerous driving condition at step 404. In response to predicting that the vehicle 102 is approaching a potentially dangerous driving condition, the ECU 108 can initiate a countermeasure to prevent the potentially dangerous driving condition at step 406.

Step 404 can include loading, by the ECU 108, the spatio-temporal probability data, personalized data for use in the predictive model, environmental factors, location data, infrastructure data, etc. to be analyze together with the vehicle data. For example, this loaded data can be inputs in the machine learning model. In this manner, the machine learning algorithm can take into account both historical data, as well as real-time vehicle data. In this regard, the ECU 108 can both provide real-time driver assistance, as well as providing vehicle/traffic data to the remote server 104 for training/updating machine learning models based on historic data for predicting potentially dangerous driving conditions.

In various aspects, step 404 can include determining whether the potentially dangerous driving condition is determined to occur within a predetermined duration. For example, the ECU 108 can determine a potentially dangerous driving condition along a predicted route of the vehicle 102. The ECU 108 can wait to implement any associated countermeasures until the dangerous driving condition is determined to occur within the predetermined duration (e.g., within 5 seconds, 10 seconds, 30 seconds, or any other suitable duration that allows the driver to timely react). The ECU 108 can activate a “soft” countermeasure a first predetermined duration before the potentially dangerous driving condition is anticipated to occur to give a warning to a driver. The ECU 108 can activate a “hard” countermeasure a second predetermined duration before the potentially dangerous driving condition is anticipated to occur to modify a vehicle parameter to prevent the potentially dangerous driving condition. The second predetermined duration can be less than the first predetermined duration.

The ECU 108 can further determine whether the driver responds to the “soft” countermeasure within a predetermined duration. If the driver responds to the countermeasure and/or takes corrective action in a manner that reduces the likelihood of the potentially dangerous driving condition from occurring below a set threshold within the predetermined duration, the ECU 108 can determine that the potentially dangerous driving condition is avoided and not take any further corrective action, such as implementing a “hard” countermeasure. If the driver does not respond within the predetermined duration, or if the driver's response does not lower the likelihood of the potentially dangerous driving condition from occurring below the set threshold, the ECU 108 can proceed with further countermeasures.

FIG. 5 is a flow diagram of an example process 500 for predictive driver assistance. One or more computers or one or more data processing apparatuses, for example, the ECU 108 and the remote server 104 of the driver assistance system 100 of FIG. 1, appropriately programmed, may implement the process 500. Various aspects of the process 500 are similar to the process described with respect to FIG. 2.

With combined reference to FIG. 1, FIG. 2, and FIG. 5, the remote server 104 can receive vehicle sensor data from the one or more sensors 114 at step 502. The remote server 104 can further receive infrastructure data (e.g., via the traffic infrastructure 250) at step 502. The remote server 104 can input the vehicle sensor data, which in various aspects can be pre-processed as described with respect to FIG. 2, into the machine learning engine 264 to generate a supervised machine learning model 266 at step 504. The server 104 can create a spatio-temporal probability data 268 based on the vehicle data at step 506. The server 104 can send the supervised machine learning model 266 and/or the spatio-temporal probability data 268 to the vehicle 102 at step 508, for example via the network 106.

In various aspects, the historical driving data (e.g., the spatio-temporal probability data 268) can be updated each time the vehicle's pre-collision system is activated and/or at predetermined intervals (e.g., daily, weekly, etc.). In this regard, the historical driving data can include historical driving data including dates, times, and/or locations that other dangerous driving conditions have been predicted by the ECU 108 for the vehicle 102 (and/or from other vehicles).

With reference to FIG. 1, the driver assistance system 100 may use the navigation unit 112 to obtain the navigational map information including a current location of the vehicle 102 and other entity information, such as places of interest in proximity or within a threshold distance of the vehicle 102. The driver assistance system 100 may extract the current location and/or the other entity information from the navigational map information. For example, the driver assistance system 100 may use a GPS system to determine the current location of the vehicle 102. In some implementations, the driver assistance system 100 may provide the current location of the vehicle 102 to an external database (e.g., the external database 105) to obtain nearby entity information to identify different places of interest in proximity to the vehicle 102 and/or weather information.

Once the driver assistance system 100 obtains the current location of the vehicle 102, the driver assistance system 100 may obtain or generate a perceived risk level at the current location of the vehicle. The risk level can be based on a time of day, nearby events, expected pedestrian density, etc. For example, a particular intersection can have a high probability of a dangerous driving condition during rush hour traffic, whereas the same intersection can have a low probability of a dangerous driving condition during other times of the day. In another example, when the vehicle 102 is driving in adverse weather conditions the likelihood of a dangerous driving condition to occur can be more than when the vehicle 102 is driving in ideal weather conditions. For example, the driver assistance system 100 can take into account weather data, time of day data, location data, etc. received from the external database 105 and/or sensors 114 onboard the vehicle 102. Thus, the predictive models can take into account the location of the vehicle 102, environmental factors, historical driving data, and the time of day.

The driver assistance system 100 may provide the current location of the vehicle 102 to the external database 105. In response, the external database 105 may provide the corresponding location data to the driver assistance system 100, which the driver assistance system 100 receives. Location data can include weather conditions at a location of the vehicle. For example, cold weather can have adverse effects on vehicle 102 stability and handling and so the driver assistance system 100 can be configured to take into account these factors. Location data can include real-time traffic data.

In various aspects, in response to predicting dangerous driving conditions, the driver assistance system 100 can send a notification to the user device 140, for example to notify the owner of the vehicle 102 that dangerous driving condition has been determined.

The driver assistance system 100 may provide the dangerous driving condition output and/or other sensor data to a consumer. A consumer is a computing device of a person, a government agency, a business, or other entity that may use the external image data. For example, a government agency, such as the police department, may use the dangerous driving condition data to identify a vehicle that caused an accident. In another example, the driver assistance system 100 may provide external image data that includes image data of the vehicle that collided, or nearly collided, with the vehicle 102 including the license plate number, make, and model of the vehicle and circumstances of the accident, to an insurance company or other consumer.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A driver assistance system, comprising:
one or more vehicle sensors; and
one or more processors configured to:
receive a vehicle data from the one or more vehicle sensors, the vehicle data includes a location of a vehicle;
analyze the vehicle data using a machine learning predictive model to predict a driving condition at a geographic location that the vehicle is approaching; and
in response to predicting the driving condition at the geographic location that the vehicle is approaching, initiate a countermeasure to prevent the driving condition from occurring.

2. The driver assistance system of claim 1, wherein the countermeasure includes adjusting a threshold of the driver assistance system in response to the vehicle approaching the geographic location.

3. The driver assistance system of claim 1, wherein the countermeasure includes adjusting a parameter of the vehicle in response to the vehicle approaching the geographic location.

4. The driver assistance system of claim 1, wherein the countermeasure includes sending a driver assistance message to a user interface in the vehicle warning a driver of the vehicle of the predicted driving condition in response to the vehicle approaching the geographic location.

5. The driver assistance system of claim 1, wherein the one or more processors is further configured to:
create a spatio-temporal probability data based upon the vehicle data, the spatio-temporal data includes a history of traffic events at one or more geographic locations for a plurality of vehicles and a history of driver events at the one or more geographic locations for the vehicle; and
the machine learning predictive model uses the spatio-temporal probability data to predict the driving condition at the geographic location that the vehicle is approaching.

6. The driver assistance system of claim 5, wherein the one or more processors is further configured to process the vehicle data to determine at least one of:
a geographic location of the vehicle where a pre-collision system of the vehicle was activated;
a driver event;
a traffic event;
a near miss event; or
an anomaly event.

7. The driver assistance system of claim 5, wherein the one or more processors includes an electronic control unit located onboard the vehicle and a remote server, the electronic control unit is configured to:
send the vehicle data to the remote server, the creating the spatio-temporal probability data based upon the vehicle data is performed using the remote server; and
receive the spatio-temporal probability data from the remote server via a wireless network.

8. The driver assistance system of claim 5, wherein the one or more processors is further configured to apply a machine learning framework to generate the machine learning predictive model.

9. The driver assistance system of claim 8, wherein the one or more processors includes an electronic control unit located onboard the vehicle and a remote server, the electronic control unit is configured to:
send the vehicle data to the remote server, the applying the machine learning framework to generate the machine learning predictive model is performed using the remote server; and
receive the machine learning predictive model from the remote server via a wireless network.

10. A method, comprising:
receiving a vehicle data from one or more vehicle sensors, the vehicle data includes a location of a vehicle;
analyzing the vehicle data using a machine learning predictive model to predict a driving condition at a geographic location that the vehicle is approaching; and
in response to predicting the driving condition at the geographic location that the vehicle is approaching, initiating a countermeasure to prevent the driving condition from occurring.

11. The method of claim 10, wherein the countermeasure includes adjusting a threshold of the machine learning predictive model in response to the vehicle approaching the geographic location.

12. The method of claim 10, wherein the countermeasure includes adjusting a parameter of the vehicle in response to the vehicle approaching the geographic location.

13. The method of claim 10, wherein the countermeasure includes sending a driver assistance message to a user interface in the vehicle warning a driver of the vehicle of the predicted driving condition in response to the vehicle approaching the geographic location.

14. The method of claim 10, further comprising:
creating a spatio-temporal probability data based upon the vehicle data, the spatio-temporal data includes a history of traffic events at a geographic location for a plurality of vehicles and a history of driver events at the geographic location for the vehicle; and
the machine learning predictive model uses the spatio-temporal probability data to predict the driving condition at the geographic location that the vehicle is approaching.

15. The method of claim 14, further comprising processing the vehicle data to determine at least one of:
a geographic location of the vehicle where a pre-collision system of the vehicle was activated;
a driver event;
a traffic event;
a near miss event; or
an anomaly event.

16. The method of claim 14, further comprising:
sending the vehicle data from the vehicle to a remote server, the creating the spatio-temporal probability data based upon the vehicle data is performed by the remote server; and
receiving the spatio-temporal probability data from the remote server via a wireless network.

17. The method of claim 14, further comprising applying a machine learning framework to generate the machine learning predictive model.

18. The method of claim 17, further comprising:
sending the vehicle data from the vehicle to a remote server, the applying the machine learning framework to generate the machine learning predictive model is performed by the remote server; and
receiving the machine learning predictive model from the remote server via a wireless network.

19. A non-transitory computer-readable medium having stored contents that cause one or more computing systems to perform automated operations, the automated operations including at least:
receiving, by the one or more computing systems, a vehicle data from at least one vehicle sensor, the vehicle data includes a location of a vehicle;
analyzing, by the one or more computing systems, the vehicle data using a machine learning predictive model to predict a driving condition at a geographic location that the vehicle is approaching; and
in response to predicting the driving condition at the geographic location that the vehicle is approaching, initiating, by the one or more computing systems, a countermeasure to prevent the driving condition from occurring.

20. The non-transitory computer-readable medium of claim 19, wherein the countermeasure includes at least one of:
adjusting a threshold of the machine learning predictive model in response to the vehicle approaching the geographic location;
adjusting a parameter of the vehicle in response to the vehicle approaching the geographic location; or
sending a driver assistance message to a user interface in the vehicle warning a driver of the vehicle of the predicted driving condition in response to the vehicle approaching the geographic location.
